(19) United States
(12) Patent Application Publication
(10) Pub. No.: US 2006/0106477 A1
(43) Pub. Date: May 18, 2006

(54) Production plan creation system, method, and program

(76) Inventor: Kazuo Miyashita, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/520,522

(22) PCT Filed: Jul. 8, 2003
(86) PCT No.: PCT/JP03/08649

§ 371 Date: Sep. 26, 2005

(30) Foreign Application Priority Data
Jul. 9, 2002 (JP) 2002-199434
Oct. 8, 2002 (JP) 2002-294665

(51) Int. Cl. G06F 19/00

(52) U.S. Cl. 700/103; 700/97

(57) ABSTRACT

The present invention is to formulate a production plan 5 by means of an event-based simulator 4 simulating movement of products within a factory through use of a production process model 2 and a production rule 3. There are provided a time-interval-based simulator 6 for computing the statuses of production processes at given time intervals, and a rule generator 7 for automatically deriving the production rule 3 through use of the time-interval-based simulator 6. As a result of a production plan being repeatedly formulated at high speed through use of the time-interval-based simulator 6, the rule generator 7 can automatically, efficiently formulate the production rule 3 by application of machine learning based on a consecutive optimization method. An event-based simulator 4 devises a high-quality production plan 5 using the generated production rule 3.

### FIELD OF THE INVENTION

The present invention relates to a computing system which automatically creates a production plan in a factory or the like, as well as to a system, method, and program for creating a production plan having the function of automatically formulating, not by manpower but by a computing machine, an appropriate production rule required at the time of devising of a high-quality plan.

### BACKGROUND ART

A plurality of production planning systems which support or automate devising of a production plan in a factory or the like have been proposed. Many of the production planning systems have already been commercialized domestically and overseas. Moreover, many manufacturing companies have developed proprietary systems and put them into use.

Many of the conventional production planning systems adopt an approach of finding a general solution by formulating a model by means of simplifying restrictions on a production process; that is, assuming that installation capacity is infinite, and by applying a mathematical optimizing technique, such as a linear planning technique, to the thus-simplified model.

Processes for manufacturing a high-technology part typified by a semiconductor or liquid crystal are formed by repetition of a great number of processes. Those processes are much larger in scale and more complicated than processes for manufacturing other products, such as automobiles. In normal times, the number of processes reaches hundreds, and a manufacturing lead time extends to several months (see, e.g., Non-Patent Document 1). Moreover, in the field of the high-technology part industry, new manufacturing processes are developed one after another with a view toward improving the competitiveness of products. Since the most advanced manufacturing processes are immediately applied to production of actual products, the manufacturing processes rarely run stably on a production site. On the occasion of devising a plan to manufacture high-technology parts, consideration must always be given to variable factors in manufacturing operation, such as occurrence of a failure in a manufacturing machine or a material defect in products.

Therefore, manufacture of products, such as high-technology products, involving many variable factors in manufacturing processes does not purport to eliminate work in process (WIP), which is seen in the KANBAN scheme considered to be effective in the automobile industry, which is characterized by mature manufacturing processes. It is important to set a minimum optimal quantity of inventory which enables stable production of products without being greatly affected by a change in manufacturing capability stemming from a mechanical failure or scrapping or reworking stemming from a material defect. In order to keep needless stock low, highly-accurate demand forecasting is required as a precondition. Highly-accurate demand forecasting is currently taken as an important problem in SCM of the high-technology industry. In the semiconductor industry in the U.S., forecasting a demand for about a year with an error of 22% or less is taken as an immediate desired target (see, e.g., Non-Patent Document 6).

On the occasion of implementation of a plan for manufacturing high-technology parts, manufacturing processes are of large scale and complicated. Hence, optimization using a mathematical method encounters difficulty in terms of calculation time. For example, in relation to manufacture of a semiconductor wafer, effectiveness of various job input rules or dispatching rules has hitherto been verified by means of scheduling based on a simulation method (see, e.g., Non-Patent Documents 5, 7).

In recent years, in contrast with a precise model of actual production processes, faithful simulation of a shift in the quantity of WIP (a change in statuses of respective parts; for example, a change in status is computed for each process every time processing is completed) becomes possible on a per-event basis, in association with an improvement in computing speed and a drop in the cost of a calculating machine. An approach to selecting the best production plan by repeating simulation based on a plurality of simple production rules by trial and error has become mainstream, particularly in very complicated production processes such as manufacture of a semiconductor. However, simulation of large-scale and complicated production processes is still very time-consuming. Therefore, finding a production rule suitable for devising a high-quality production plan by trial and error is difficult. The conventional production planning system is not provided with a support function for finding the most important and difficult production rule. For this reason, there is no way but to relay solely on the skill and guesswork of a production planning worker in devising a high-quality production plan.

There is an example study case where an attempt is made to automatically generate an appropriate rule with a calculating machine by development of an artificial intelligence (AI) technique and where the rule is applied to the production plan problem (e.g., “Learning scheduling control knowledge through reinforcement” Miyashita, K., International transactions in operational research, Vol. 7, No. 2, pp. 125 to 138, 2000, “Job-Shop Scheduling with Genetic Programming” Miyashita, K., Proc. of the Genetic and Evolutionary Computation Conference, pp. 505 to 512, 2000, “Two-stage Learning Method for dynamic job shop scheduling—robust scheduling using a hierarchical neural network” and Eguchi et al., Scheduling Symposium, pp. 89 to 94, 2001). However, application of these techniques to a production plan problem intended for actual large-scale production processes is difficult to realize, in view of the time required to learn rules. A practical production plan system having the function of automatically generating appropriate production rules still does not exist.

Scheduling based on the conventional simulation scheme has the following drawbacks (see Non-Patent Document 8).

When an appropriate product mix or an input rate is determined, performing sufficient examination by trial and error in consideration of variations in actual manufacturing processes is still very time-consuming.

The work determined by simulation is easy to dissociate from actual manufacturing conditions for reasons of various variable factors in an actual production site, and an effective work instruction to address such a situation cannot be carried out smoothly.

In order to counter the problems, a more high-speed, robust, and production-instructive simulation technique is required to devise a plan for producing high-technology parts.

∂Non-Patent Document 1]

Linda F Atherton and Robert W. Atherton. Wafer fabrication; Factory performance and Analysis. Kluwer Academic Publishers, 1995.

[Non-Patent Document 2]

L. Gong and H. Matuo. Control Policy for manufacturing system with random yield and rework. Journal of Optimization Theory and Applications, 95(1): 149-175, 1997.

Non-Patent Document 3]

Wallace J. Hopp and Mark L. Spearman. FACTORY PHYSICS. McGraw-Hill, second edition, 2000.

Non-Patent Document 4]

J. D. C. Little. Proof of the queueing formula L=λW. Operations Research, 9:383387, 1961.

[Non-Patent Document 5]

Oliver Rose. The shortest processing time first (SPTF) dispatching rule and some variants in semiconductor manufacturing. In Proceeding of the 2001 Winter Simulation Conference, pages 1220-1224. INFORMS, 2001.

[Non-Patent Document 6]

Robin Roundy. Report on practices related to demand forecasting for semiconductor products. Technical report, School of Operations Research and Industrial Engineering, Cornell University, 2001.

[Non-Patent Document 7]

Lawrence M. Wein. Scheduling semiconductor wafer fabrication. IEEE transaction on Semiconductor Manufacturing, 1(3): 115-130.1988.

[Non-Patent Document 8]

Masahiro Arakawa, Masahiko Fuyuki, Ichiro Inoue. Examination of optimization-oriented simulation base scheduling method in APS, Lecture Paper Collection of Scheduling Symposium 2001, pp. 47 to 52, Scheduling Society, 2001

[Non-Patent Document 9]

Hiroyuki Kashiwase. Method for scheduling production of semiconductor and high-speed simulation model, Master's thesis, Tsukuba University, 2002.

### DISCLOSURE OF THE INVENTION

According to the conventional production planning technique, an appropriate production rule to be used for devising a high-quality production plan must be provided in advance by a human. However, it is difficult to formulate a production plan rule appropriate for large-scale, complicated production processes with manpower.

Even when a learning method for a conventional artificial intelligence technique is merely applied to the technique, automatic generation of rules for large-scale, complicated production processes, such as those for semiconductor production, is very time-consuming, and hence impractical.

The major object of the present invention is to significantly improve the efficiency of production of products, such as semiconductors, involving large-scale, complicated production processes.

A lower-priority object of the present invention is to significantly improve the efficiency of production of products, such as semiconductors, involving large-scale, complicated production processes, by realizing a production planning system having the function for automatically generating production rules, which enables devising of a high-quality production plan at high speed.

Another lower-priority object of the present invention is to significantly improve the efficiency of production of products, by controlling production processes such that the quantity of work in process falls within a predetermined range.

A system, method, and program of the present invention for formulating a production plan are to devise a production plan by simulating movement of products within a factory by an event-based simulator through use of a production process model and a production rule. The system, method, and program have a time-interval-based simulator for computing the statuses of production processes at uniform time intervals, and a rule generator for automatically deriving the production rule through use of the time-interval-based simulator. The production plan is repeatedly devised over and over again at high speed through use of the time-interval-based simulator, thereby applying mechanical learning based on a consecutive optimization method to the rule generator, to thus formulate the rule. Thereby, the production rule can be formulated automatically and efficiently. The event-based simulator formulates a high-quality production plan through use of the thus-generated production rule.

The present invention is characterized by comprising a simulator for repeatedly computing the quantity of WIP in manufacturing processes; and a control system which determines a parameter used for computation of the simulator such that a computation result of the simulator becomes equal to an allowable range or less and which performs production control of the production process on the basis of the parameter.

### BRIEF DESCRIPTION OF THE DRAWINGS

FIG. 1 is a block diagram showing an embodiment of a production planning system according to the present invention;

FIG. 2 is a flowchart showing the outline of processing of a time-interval-based simulator;

FIG. 3 is a view showing details of specific information about a product, processes, and machinery included in a production process model and a production plan;

FIG. 4 is a view showing performance of a time-interval-based simulator plotted on a time axis;

FIG. 5 is a flowchart showing the outline of production status update processing;

FIG. 6 is a view showing an example learning model of a part input rule using a neural network;

FIG. 7 is a view showing a cyclic shift in WIP in processes;

FIG. 8 is a view showing a shift in WIP in terms of Periods;

FIG. 9 is a block diagram showing a system configuration according to a second embodiment; and

FIG. 10 is a flowchart showing processing procedures of a production system.

### BEST MODE FOR IMPLEMENTING THE INVENTION

### First Embodiment

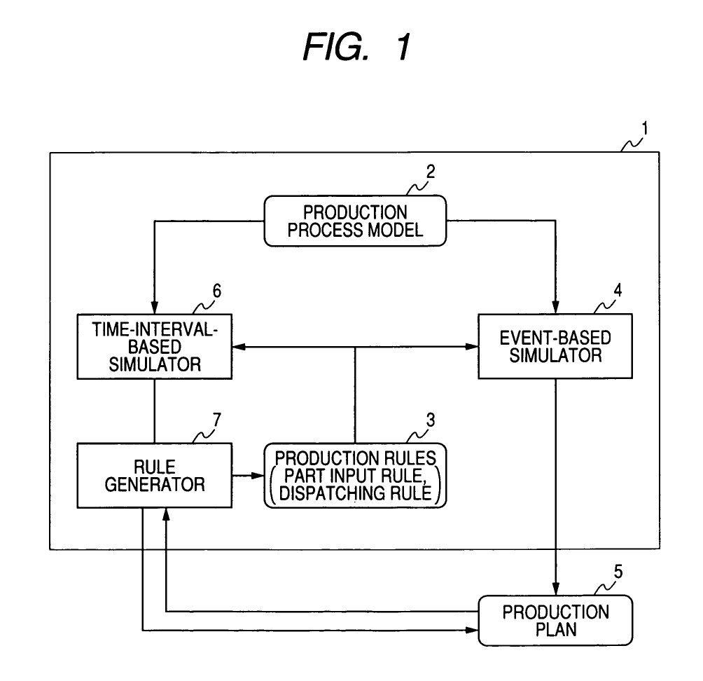

Preferred embodiments of the present invention will now be described hereinbelow by reference to the drawings. FIG. 1 is a block diagram showing an embodiment of a production planning system according to the present invention. A production process model 2 represents, as a model in a computer, information pertaining to manufacturing operation in a factory where products are manufactured. Information represented as a model includes information about manufacturing equipment (e.g., the type of equipment, the number of pieces of equipment, the capacity of the pieces of equipment, failure rates of the pieces of equipment, or the like); information about workers engaged in production (a shift, capabilities of the workers, the number of workers, or the like); information about a method for manufacturing products (e.g., machinery to be used, workers, a processing time, a transport time, a non-defective rate, a reworking rate, or the like); information about products (e.g., the quantity of production, an input time, a due date, or the like), etc. A detailed model pertaining to an actual factory is prepared in the computer on the basis of the foregoing information items, and movement of products in the factory is simulated using the model. From the result of simulation, a production plan draftsman acquires information about the time by which input products are finished and the quantity of work in process which will arise in each machine, thereby formulating a desirable production plan 5.

A block 1 shown in FIG. 1 represents the entire production planning system. The production process model 2 is a static model of a factory representing the performance of machinery installed in the factory, the number of machines, processes for products to be produced in the factory, and a quantity of products. The manner in which materials actually flow within the factory and in which the materials are dynamically changed to products cannot be simulated by only such information. The dynamic aspect of the factory to be embodied as a model is a set of production rules 3. The main production rules 3 required by the production planning system 1 are roughly divided into two types of rules.

One type of rule is a part input rule for determining a timing at which materials of products are to be input. This type of rule encompasses, e.g., a rule for inputting a given quantity of material at a given interval and a rule for newly inputting the quantity of material corresponding to the quantity of products shipped. Another important type of production rule 3 is called a dispatching rule. This dispatching rule is for determining which of parts is input when the production machine of the factory has become able to perform machining under circumstances where a plurality of parts await machining in a buffer in front of the production machine. Many rules, such as a (First In First out) rule for prioritizing a part having first entered a buffer and an (Earliest Due Date) rule for prioritizing parts for products whose due dates will be earliest have already been proposed [R. W. Conway et al., “Theory of Scheduling,” Addison-Wesley (1986)]. The production rules 3 control all of the dynamic aspects of the factory, and hence the state of production in the factory greatly changes according to the nature of the production rules 3 used. Therefore, the most important duty of a production administrator of the factory is to determine the nature of the production rules 3 which would realize efficient production when applied to the production process model 2 of the factory of object. The related-art production planning system 1 is based on premise that a production plan draftsman inputs the production rules 3. In contrast, the function for supporting the user is embodied by only preparing a plurality of general rules in advance in a selectable manner.

When the production process model 2 and the production rules 3 are defined, production processes in the actual factory can be simulated using information about the model and the rules. An event-based simulator 4 runs this simulation. The event-based simulator 4 consecutively advances an internal clock and simulates a dynamic change in the production processes by application of the production rules 3 in accordance with a change (also called an “event”) having arisen at that timing. For instance, when machining by one machine in the production process model 2 finishes at a certain time (i.e., a value determined by adding a machining time to a machining start time coincides with a current time with regard to a part currently being processed by that machine in the event-based simulator 4), apart to be machined next is selected from the parts awaiting machining in the buffer of the machine through use of the dispatching rule(s) of the production rules 3. If required conditions, such as an operator and a material, are satisfied, processing is commenced. The event-based simulator 4 advances the internal clock by performing the foregoing operation from the simulation start time to the simulation end time, thereby reproducing all changes which would be expected to arise within the period of time in the factory, and outputs the result of reproduction as a production plan 5. Information that the nature of parts and quantities of the parts will be machined by the respective machines in the factory is recorded along a time axis on the production plan 5. Further, various values pertaining to production, such as an operation rate of facilities, a production lead time, and a lag behind a due date, are computed on the basis of the information, and the computed values are evaluated as the quality of the formulated production plan 5.

The production process model 2, the production rules 3, the event-based simulator 4, and the production plan 5, which have been described thus far, remain unchanged from their counterparts in the related art. The characteristic of the present invention lies in that the production planning system 1 is provided with a time-interval-based simulator 6 and a rule generator 7 for automatically generating the production rules 3 at high speed. As mentioned previously, the production rules 3 are important rules for determining the dynamic characteristic of the factory, and the quality of the production rules 3 determines the quality of the production plan 5 to be formulated. Therefore, high-speed, automatic generation of the appropriate production rules 3 yields an effect of remarkably improving the production efficiency of the factory.

The basic principle for generating an appropriate production rule 3 using artificial intelligence (AI) technology is consecutive optimization [T. Mitchell, “Machine Learning,” McGraw-Hill (1997)]. Specifically, processing for formulating the production plan 5 through use of a certain set of production rules 3 and improving the production rule 3 such that the quality of the formulated plan is improved is consecutively repeated, thereby generating a more pertinent set of production rules 3. Since an actual factory which will be an object of implementation of a production plan is of large scale and complicated, a massive amount of computing time is required to repeatedly formulate the production plan 5. In the meantime, products generally manufactured in the factory and facilities used for production are not invariant. Conversely, in the current production environment involving high competition and production of small batches of a variety of products, the products and the facilities are usually changed in short cycles. Consequently, even if the production rules 3 can be automatically generated with consumption of an enormous amount of computing time, the production process model 2 of the factory may have already been changed when the thus-generated production rule is used, and the generated production rules 3 are highly likely to become ineffective. Actual practicality of the production rules 3 generated by such a technique is low.

Therefore, in order to embody the production rule 1 effective for an actual production site, the production rules 3 must be generated as appropriate at an appropriate timing at which the production rule does not become irrelevant to a change in actual production environment. In order to automatically, efficiently generate the production rules 3, there is required a simulator capable of repeatedly formulating a production plan at high speed over and over again through use of the rule generator 7 to which machine learning based on a consecutive optimization technique is applied. The simulator is inevitably the time-interval-based simulator 6 shown in FIG. 1.

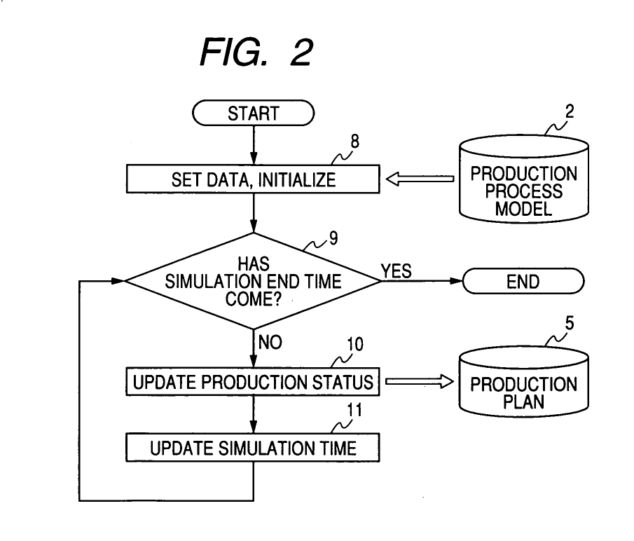

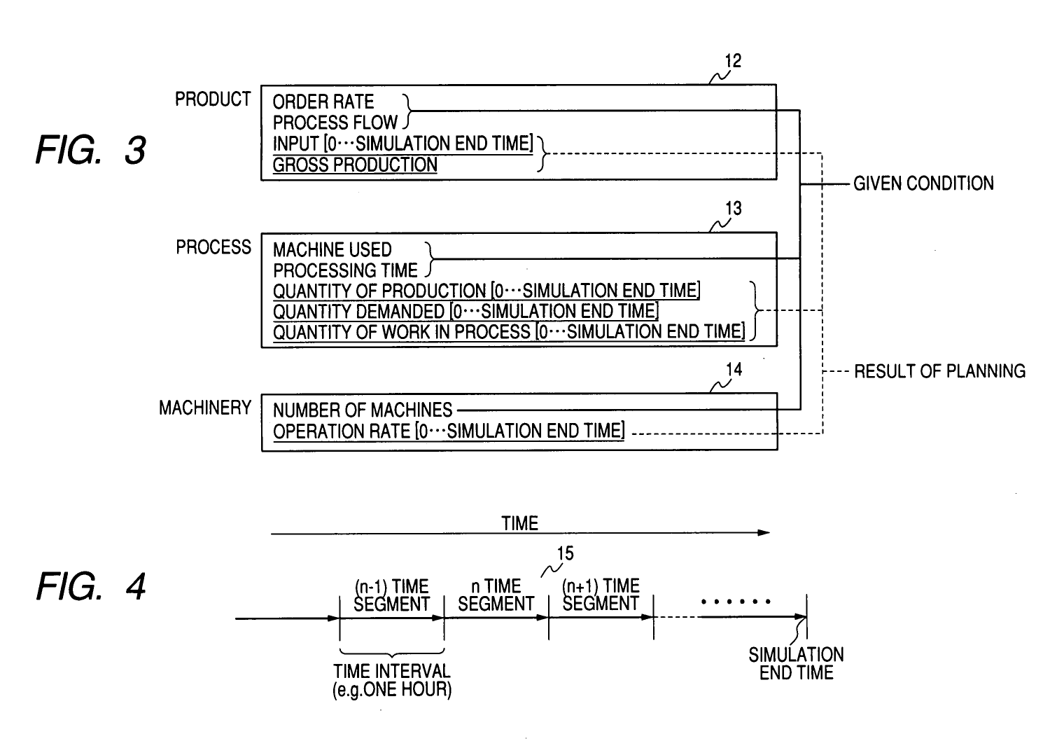

FIG. 2 is a flowchart showing the outline of processing of the time-interval-based simulator 6. The time-interval-based simulator 6 formulates the production plan 5 using the data included in the production process model 2. First, at the occasion of commencement of processing, the simulator performs setting of required data and initialization 8. FIG. 3 shows the production process model 2 and detailed product information12, detailed process information 13, and detailed machinery information 14, all being included in the production plan 5. During the data initialization 8, initialization of data to be included in the finally-formulated production plan 5 is performed; that is, initialization of quantity of input, gross production, quantity of production, quantity demanded, quantity of work in process, and an operation rate, all being shown in FIG. 3. Production plan formulation requirements described in the production process model 2, such as an order rate, a process flow, machines used, a processing time, and the number of machines, all being shown under given requirements in FIG. 3, are read from the data file, whereupon a time interval at which simulation is to be run and an end time are set.

FIG. 4 is a view showing performance of simulation by the time-interval-based simulator 6 plotted on a time axis. At the time of performance of the simulation by the time-interval-based simulator 6, updating of the production status 10 is repeated until the simulation end time comes, in accordance with the time interval set through the data setting and initialization 8 (step 9). Here, the time interval specifies the frequency at which details relating to running of simulation are repeatedly updated. No shift is assumed to arise in the quantity of work in process within a predetermined time interval (e.g., one hour). Performance of simulation means computation of a progress in production in each time interval (herein called a time segment 15) by advancing the internal clock of the simulator on a per-time-interval basis. When compared with the volume of computation required by the conventional event-based simulator 4 that frequently updates the status of a progress in production every time an inventory shift arises within a production process, which is an event, the volume of computation is greatly diminished by appropriately setting the time interval. As a result, simulation can be performed efficiently while the accuracy of simulation result is maintained.

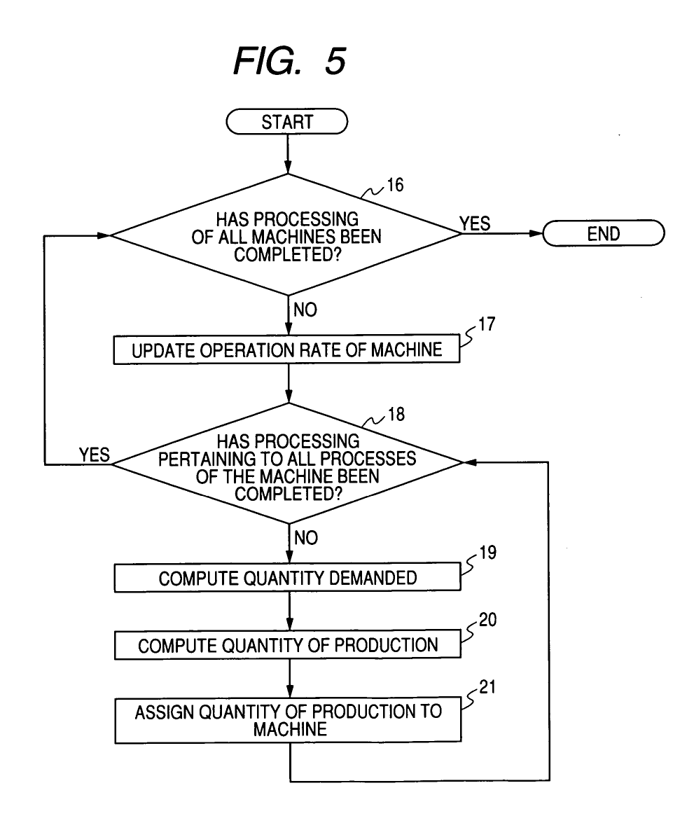

FIG. 5 is a flowchart showing the outline of processing pertaining to production status update 10. When the time-interval-based simulator 6 performs processing pertaining to the updating of a production status 10, the quantity of parts produced every predetermined time interval is computed in connection with all of the machines included in the production process (step 16). At this time, of the parts input into the machine until an immediately-before time segment, the quantity of parts having hitherto finished undergoing processing is computed. The capability of the machine assigned to the parts is released, thereby updating the value of operation rate of the machine (step 17). Subsequently, the quantity of parts to be produced within the set time interval is computed in connection with all processes by way of which the parts are to be processed by the machine (step 18). At that time, the quantity of production demanded pertaining to a process falling within the current time segment is computed (step 19). If this process is a leading process of products, the quantity demanded is computed by the part input rule of the production rule 3 described previously. If this process is not the leading process, the quantity demanded is set so as to become equal to the sum of the quantity of products finished in a preceding time segment of a preceding process and the quantity of work remaining in the process in the preceding time segment. Specifically, all of the worked parts originating from the preceding process having arisen in the preceding time segment are presumed to be shifted to that process and processed in the current time segment. Next, the quantity of production which can be actually realized is computed in connection with the thus-computed quantity demanded (step 20). At that time, when the demanded quantity of production determined above includes the quantity of parts produced by the machine capability available in the current time district (i.e., the number of machines×operation rate×time interval/processing time) and the quantity demanded exceeds the machine capability, the quantity of inventory to be processed in the next time segment and subsequent time segments is computed (step 21). Finally, the machine capability [i.e., a time interval/(the number of machines×processing time)] to be assigned to production for yielding the thus-computed quantity of production is determined, to thus update the operation rate of the machine (step 22). The quantity of production yielded by the machine by way of the overall processes is computed in succession (step 18). Here, the sequence of processes for assigning parts to the single machine is determined through use of the dispatching rule of the production rules 3.

As mentioned above, high-speed formulation of a production plan becomes feasible through use of the time-interval-based simulator 6. Even when the time-interval-based simulator 6 is used, the part input rule and the dispatching rule of the production rules 3 are required as described previously. For this reason, there is realized automatic generation of the production rules 3 that enables formulation of the production plan 5 suitable for the production process model 2, by means of generating rules using the rule generator 7, and evaluating the quality of the formulated production plan 5 to thus consecutively improve the production rules. Proposed as a method for realizing the rule generator 7 are various machine learning techniques based on consecutive optimization in the field of artificial intelligence, such as Neural Network [C. M. Bishop, “Neural Networks for Pattern Recognition,” Oxford University Press (1995)], Classifier System [P. L. Lanzi et al., “Learning Classifier System,” Springer (2000)], and Decision Tree Learning [J. R. Quinlan, “C4.5: Programs for Machine Learning,” Morgan Kaufmann (1993)]. Basically, the rule generator can be realized by use of anyone of the foregoing techniques. Here, an embodiment using a neural network in the rule generator 7 will be described here as an embodiment of the present invention. The concept of the present invention is not limited to the embodiment using the neural network and encompasses all machine learning techniques where the rule generator is based on consecutive optimization.

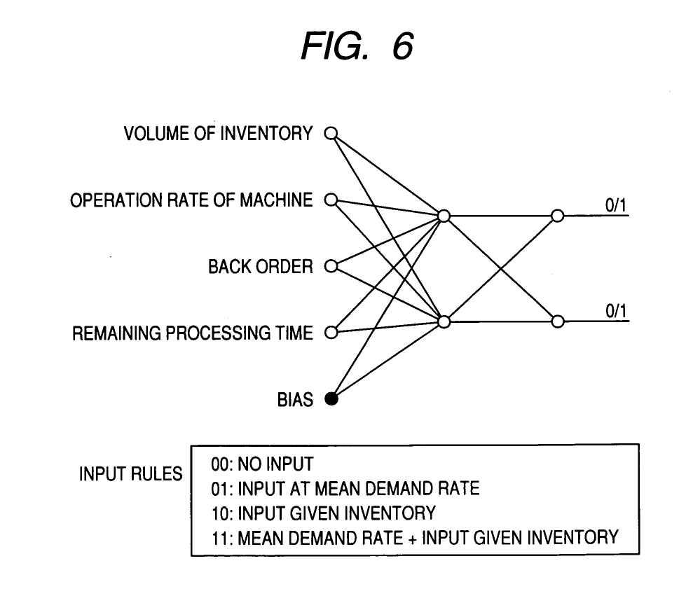

FIG. 6 shows an example learning model of a part input rule using a neural network as an embodiment. This neural network is disposed for each machine or each production planning system 1. Used as information input to the neural network are information items quantitatively showing the statuses of production processes and the status of an order, such as the quantity of inventory, an operation rate of machinery, a back order with reference to a due date, and the sum of remaining processing periods of time required to perform processing pertaining to processes by machines. An output from the neural network corresponds to a part input rule (any one of four types of rules 00 to 11) to be selected in such a situation. At the time of learning of the neural network, a weighting value existing between nodes assigned random values is improved by use of the consecutive optimization technique such as limited annealing, whereby the part input rule which enables output of the high-quality production plan 5 is learned. At this time, the quality of the production plan 5 created through use of an aggregate of weighting values of a certain node is evaluated. The weighting values are consecutively changed such that the quality of the production plan 5 is improved, by means of the influence stemming from a minute change in the weighting values. Hence, production plan formulation processing must be performed an enormous number of times, on the order of thousands of times to tens of thousands of times. For this reason, it is difficult for the related-art event-based simulator 4 to apply the production plan formulation processing to formulation of a production plan of a factory of usual scale, and the time-interval-based simulator 6 of the present invention is inevitably employed.

### Second Embodiment

In the present embodiment, there is proposed a production scheme for shifting work in processes within only a given time cycle in order to realize stable production in defiance of various fluctuations in manufacture. The previously-described time-interval-based simulation 6 is applied as the simulation technique to the proposed production scheme. Moreover, it is shown that the time-interval-based simulation 6 based on the proposed production scheme enables computation of an equivalent computational result tens of times as fast as does the related-art simulation technique, through use of data pertaining to actual semiconductor wafer production processes (preceding processes).

CONSTIN” Production Scheme

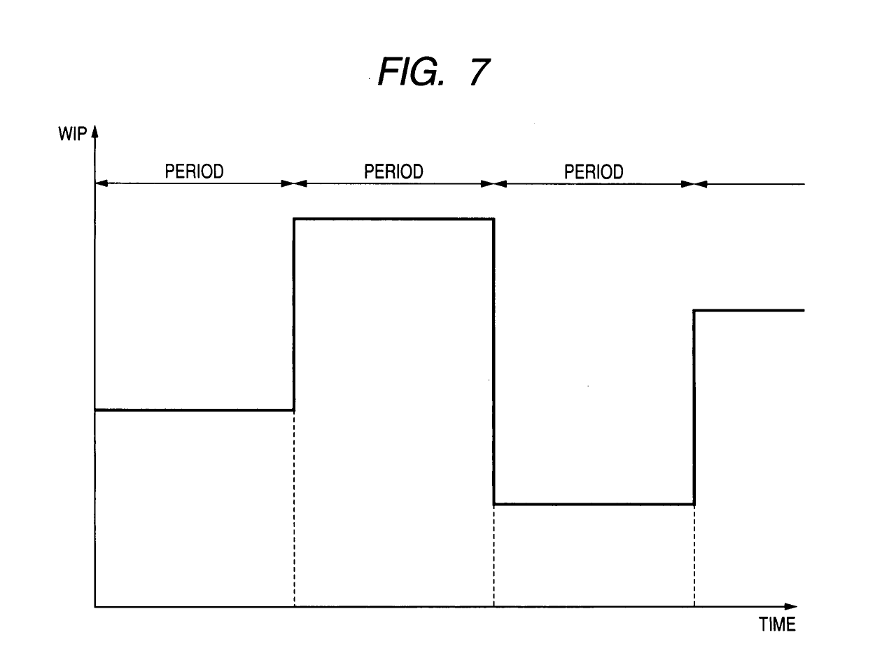

The present inventor proposes a “CONSTIN” (CONStant Time Interval) production scheme as a production scheme which enables performance of robust production, in connection with large-scale, complicated manufacturing processes having greatly variable elements. According to CONSTIN, all of the manufacturing processes are exercised synchronously, and work in process shifts from one process to another process within only a given cycle (see FIG. 7). Moreover, the extent over which work in process shifts during one cycle is one process at the maximum; in other words, work in process does not shift beyond the next process.

In CONSTIN, even when fluctuations, such as breakdown of machinery or material defects, have arisen in a certain process, the influence of fluctuations can be prevented from spreading across the processes, so long as the fluctuations are solved within the cycle or a sufficient quantity of work in process is planned in a process preceding or subsequent to the current process. Therefore, the CONSTIN scheme can be said to be a production scheme which enables performance of robust manufacturing.

However, CONSTIN improves robustness by limiting free movement of WIP, and valuable production capabilities (resources) cannot be effectively utilized without appropriate operation. In the embodiment, simulation shows that such a problem is solved by appropriately setting the value of the cycle and the quantity of inventory in respective processes.

Model

A model of production processes in the CONSTIN production scheme handled in the present embodiment is described in general terms hereinbelow. Mathematical approximate analysis of this model is provided by Gong et al. (see Non-Patent Publication 2).

In the present embodiment, the model is formulated through use of the following symbols:

m=number of workstations:

g=number of products;

nₚ=number of processes performed for a product p (where n₀=0);

n=the total number of processes performed for all products;

c=(c₁, c₂, . . . , cm)^{T}, production capabilities of workstations in one cycle;

sᵢ=processing time in process i;

S=m×n processing time matrix; the value of an element (k, i) achieved when processing pertaining to a process i is performed by a workstation k is sⱼ, and 0 in all other cases;

rₚ(t)=the quantity of input required during cycle t of product p
x(t)=x₁x₂(t)₁ . . . , xₙ(t)^{T}; the quantity of production started in process i(1≦i≦n) during cycle t.
w(t)=w₁w₂(t)₁ . . . , wₙ(t)^{T}; the quantity of WIP in process i(1≦i≦n) during cycle t.
z(t)=z₁z₂(t)₁ . . . , zₙ(t)^{T}; the quantity of production in process i(1≦i≦n) during cycle t.
u(t)=u₁u₂(t)₁ . . . , uₙ(t)^{T}; the quantity of rework in process i(1≦i≦n) during cycle t.
v(t)=v₁v₂(t)₁ . . . , vₙ(t)^{T}; the quantity of scrap generated in process i(1≦i≦n) during cycle t.

A shift in WIP during each cycle in the CONSTIN scheme is represented as follows:

[Mathematical Expression 1]
wᵢ(t+1)=wᵢ(t)+rₚ(t)−(zₙ(t)−uᵢ(t))
In all other cases, the shift is represented as

[Mathematical Expression 2]
wᵢ(t+1)=w₁(t)+(zᵢ₋₁(t)−uᵢ₋₁(t)−uᵢ₋₁(t))−(zᵢ(t)−uᵢ(t)
The quantity of production to be started and the quantity of production in each cycle cannot exceed the quantity of WIP acquired at that point in time. Hence, the following expression stands. When the lead time in the process is longer than a set cycle, the quantity of production to be started is not always larger than the quantity of production.

[Mathematical Expression 3]
xᵢ(t)≦wᵢ(t)

[Mathematical Expression 4]
zᵢ(t)≦wᵢ(t)

The production capabilities of the workstations are limited, and production in excess of the production capabilities cannot be commenced. Therefore, the following restrictions exist.

[Mathematical Expression 5]
Sx(t)≦c
Simulation Technique

According to the CONSTIN production scheme, full computation of status changes attributable to all events which will arise in production processes, as is done in related-art event-driven simulation, is not performed. Production processes can be simulated by computing a shift in the quantity of WIP in respective processes for each cycle. Therefore, in contrast with the related-art simulation technique, a remarkable improvement in computing speed is expected, and the production scheme is considered to be effective as a technique for simulating large-scale, complicated production processes for high-technology parts.

Outline of Simulation Method

Simulation complying with the CONSTIN scheme is performed by exercising a loop represented by Mathematical Expression 6.

[Mathematical Expression 6]

```
initialize Data( );
t = 0;
while (t [symbol] EndOfSimulation) {
  runForPeriod( );
  t = t + Period :
}
```

Parameters to be set at that time include a Period constant used for determining the cycle of CONSTIN and an EndofSimulation constant used for determining a simulation time. A guide employed for determining the Period constant will be described later. On the occasion of determination of the latter; that is, the simulation time, only the time required to make a simulation result stable must be set. Therefore, as the value of Period becomes larger, a larger value must be set for EndOfSimulation.

By means of a runForPeriod function which is the core of simulation, a shift in WIP is computed by the respective workstations, as represented by Mathematical Expression 7.

The quantity of WIP at simulation time “t” in a leading process is determined by adding to the preliminary quantity of WIP the quantity of newly input parts. CONSTIN can realize MRP push-type production or CONWIP (see Non-Patent Document 3) pull-type production by means of changing a releaseRule function in Mathematical Expression 7 pertaining to the input rule (Non-Patent Document 9)

[Mathematical Expression 7]

```
for (each workstation in the fab) {
  for (each step of the workstation) {
    wip = WIP waiting at step;
  if (step is the first process)
    wip = wip + releaseRule(step);
  demand = wipTranferRule(wip, step);
}
  sortingRule(steps of the workstation);
  for(each step in the sorted order) {
    calcProduction (step);
  }
}
```

A rule to be used for
determining, of the quantity of WIP in each process, the quantity of WIP to be processed by the workstations in a current cycle corresponds to a wipTansferRule function in Mathematical Expression 7. Here, the quantity of shift in WIP in each process must be determined so that production can be performed as uniformly as possible, in consideration of the quantity of WIP in processes before and after the current process, the quantity of products having hitherto been finished, and operating statues of the workstations in the preceding and subsequent processes.

After the quantity of WIP to be processed in the current cycle among the quantity of WIP in respective cycles has been determined, the processing sequence of processes is determined by a sorting rule function in Mathematical Expression 7 on the basis of the priorities of the respective processes determined in the workstation. Processing pertaining to subsequent processes in this sequence cannot be processed in the current cycle, because of limitations on the processing capabilities of the workstations. A related-art dispatching rule can also be applied to determination of priorities of the respective processes. After the quantity of WIP in respective processes to be processed by the workstations and the sequence in which the WIP is to be processed have been determined, capabilities of the workstations and time required to perform the processing are computed by a calProduction function of Mathematical Expression 7 in accordance with the type of processes (e.g., lot production, batch production, or the like), whereby the operating statuses of the workstations and the quantity of WIP in respective processes are updated.

Setting of Cyclic Parameters

When simulation is run in the CONSTIN scheme, an important parameter which must be determined in advance is the Period constant. If the value of Period is made large and simulation is performed until a steady state is achieved, robustness against variable factors is high. However, many of pieces of WIP are eventually held in the processes. Conversely, if the value of Period is made small, the robustness against the variable factors becomes low, and computing speed of simulation is also decreased. Therefore, an appropriate value of Period must be set in accordance with the object of simulation. Here, the value of Period which becomes a standard at the time of determination of a value in accordance with an application can be determined as follows:

Provided that “r” is an input rate, 1ᵢ is the number of processes per workstation, and “d” is the value of Period, the quantity of production zᵢ of a workstation in one cycle in a steady state is defined as zᵢ=r1ᵢd. In CONSTIN, since the quantity of production is always smaller than the quantity of WIP

$$( {\sum }_{n = 1}^{m} {Z}_{i} \leq w ) ,$$

there stands

$${\sum }_{n = 1}^{m} r {l}_{i} d \leq w .$$

In the meantime, provided that the value of cycle time is taken as “y,” a throughput value is equal to “r” in a steady state. Hence, w=ry is derived from Little's formula pertaining to a queue (Non-Patent Document 4). From the foregoing inequality, we have

$$d \leq yl {\sum }_{n = 1}^{m} {l}_{i} .$$

Although the value of “1” is evident from the model of production processes, a value “y” is usually unknown, because the cycle time includes a queuing time in addition to including the time required by the processes. However, since the cycle time is always larger than the production lead time in the processes, there stands

$$y \geq {\sum }_{n = 1}^{m} {S}_{i} ,$$

and we have

$$d \leq {\sum }_{n = i}^{m} {S}_{i} l {\sum }_{f = r}^{m} {l}_{j} .$$

From the foregoing description, when there is not information, such as a correlation between the lead time and the cycle time in actual production processes acquired in the past, taking

$$d = α {\sum }_{i = 1}^{m} {S}_{i} l {\sum }_{j = 1}^{m} {l}_{j}$$

as a reference value of the Period parameter is appropriate by assuming

$$y = α {\sum }_{j = 1}^{m} {S}_{i}$$

(where α˜2).

Application of CONSTIN to Semiconductor Wafer Processing Process

In order to verify the effectiveness of the CONSTIN production scheme and that of a simulation technique based thereon, a numerical experiment is performed through use of data pertaining to semiconductor wafer processing. The problem used in the experiment is the benchmark problem about SEMATECH publicly released by the MASM laboratory of Arizona State University. The problem can be downloaded from URL (http://www.was.asu.edu/¥%7Emasmlab/home.htm) of the MASM laboratory.

An overview of the problem taken in the embodiment is shown in Table 1. For reasons of limitations on modeling of the event-driven simulator used for the purpose of comparison, minimum changes are made on a portion of the data pertaining to the problem from the viewpoint of the benchmark problem.

TABLE 1
Overview of Test Problem

| PRODUCT TYPE | NON-VOLATILE MEMORY |
|---|---|
| NUMBER OF PROCESS | 2 |
| FLOWS | |
| NUMBER OF TYPES | 2 (ONE FLOW FOR EACH TYPE) |
| TYPE OF WORKSTATION | 83 |
| NUMBER OF | 265 |
| WORKSTATIONS | |
| NUMBER OF PROCESSES | 210 (PRODUCT A) |
| | 245 (PRODUCT B) |
| TOTAL PROCESSING TIME | 313.4 (PRODUCT A) |
| | 358.6 (PRODUCT B) |
| QUANTITYE OF DEMANDED | 380.95 SHEETS/DAY (PRODUCT A) |
| | 190.48 SHEETS/DAY (PRODUCT B) |

Requirements for Simulation

In the present embodiment, in order to verify the CONSTIN production scheme and the basic performance of simulation based on the scheme, a test is conducted on the basis of the following assumptions; that is, (1) a processing time of a process is constant; (2) a down time is not taken into consideration; (3) operators are not taken into consideration; and (4) machine failures, discarding, and reworking do not arise. Therefore, the simulation performed in the present embodiment does not contain any random elements.

The test performed during this time used the constant input rule based on the quantity demanded as releaseRule to be used for running simulation, a rule for processing all unprocesed WIP as wipTransferRule, and a rule for prioritizing a process having a larger quantity of WIP after normalization has been performed by the input rate and the processing time as sortingRule.

In connection with the Period parameters, a mean total processing time per wafer achieved in the test is about 8862 minutes, and the mean number of processes is 221.7.

The value of Period is set to 80 minutes on the premise that α˜2. The value of EndOfSimulation parameter is set to six months so that the simulation result sufficiently achieves a steady state, and the results achieved in the last one month are analyzed and examined.

Simulation Results and Examination thereof

In order to verify effectiveness of the simulation technique proposed in the embodiment, simulation results are compared with each other through use of AutoSched ΛP manufactured by Brooks Autoamtion Co., Ltd. which is a commercially-available event-driven simulator. The result of comparison is shown in Table 2. From the comparison result, the simulation results can be said to be essentially equal to each other, except for WIP.

TABLE 2
Comparison between Simulation Results

| | CONSTIN | AutoSched |
|---|---|---|
| Quantity of production | | |
| (product A) | 237 | 239 |
| (product B) | 122 | 120 |
| WIP | | |
| (product A) | 157 | 101 |
| (product B) | 85 | 62 |
| Mean operation rate (%) | 37.9 | 38.0 |
| Computing time (sec.) | 4.5 | 106 |

In relation to the quantity of WIP, shifting of WIP is prohibited for a given period of time in the CONSTIN scheme. Hence, an increase in the quantity of WIP is natural. Presence of such WIP is responsible for an improvement in the robustness of CONSTIN. Therefore, when the value of Period is set, a trade-off between the volume of WIP and the robustness of production must be taken into consideration.

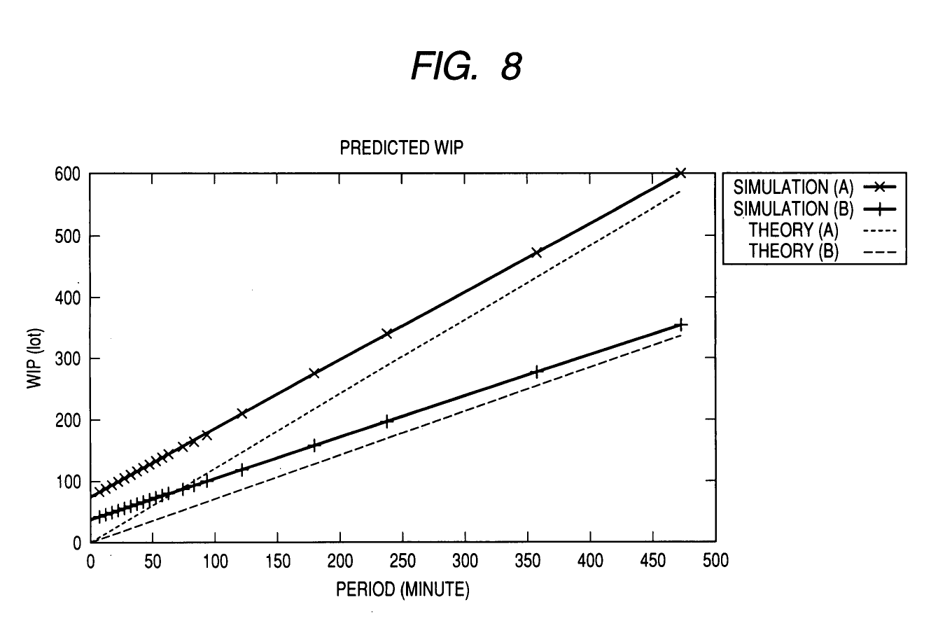

FIG. 8 shows a change in the quantity of WIP due to a change in the value of Period caused by the simulation results. As is evident from the drawing, the quantity of WIP increases essentially linearly in accordance with the value of Period.

Provided that the quantity of WIP of the product “p” is taken as Wp, there is obtained

$$\begin{matrix}{W}_{p} ( t ) = {\sum }_{{n}_{p}}^{{n}_{p}} w ; ( t ) \\ = {\sum }^{{n}_{p}} ( {w}_{i} ( t - 1 ) + \\ {z}_{i - 1} ( t - 1 ) - {z}_{i} ( t - 1 ) \\ = {\sum }^{{n}_{p}} {z}_{i - 1} ( t - 1 ) + \\ {\sum }^{{n}_{p}} ( {w}_{i} ( t - 1 ) - {z}_{i} ( t - 1 ) )\end{matrix} \qquad [ Mathematical Expression 8 ]$$

Now, when “t” assumes a sufficiently large value, simulation reaches a steady state. As a result, the quantity of input and the quantity of production become equal to each other, and the quantity of inventory becomes constant. Therefore, the value of Σⁿ^{ₚ}Zᵢ₁(t-1) converges at the sum of quantities input in all of the processes acquired during a time Period, and Σⁿ^{ₚ}(wⱼ₋₁(t-1)−z₁(t-1)) converges at a comparatively small constant.

For this reason, when the value of Period is large, we have

[Mathematical Expression 9]
\overline{W}ₚ˜\overline{rₚ}nₚPeriod
This value coincides closely with the simulation result, as shown in FIG. 8.

In relation to the processing speed, a computing time required to run simulation for six months using a PC equipped with Pentium (Trademark) 3 (1.2 GHz) is merely five seconds in the CONSTIN scheme. The processing speed is 20 times as fast as the AutoSched, which is the commercially-available event-driven simulator. When the value of Period is increased, a computing speed increases essentially linearly in CONSTIN. Therefore, when the value of Period is set to 480 in a footnote test, the computing time is about one second. Simulation can be applied to an application requiring a real-time characteristic by means of appropriately setting the value of Period.

Summary

In the processes for manufacturing semiconductor having many variable factors, smooth production becomes impossible when the inventory is curtailed excessively. However, if the inventory is not controlled appropriately, deterioration of a lead time and an increase in the quantity of dead stock will arise. In the CONSTIN scheme described in connection with the present embodiment, the magnitude of changes in manufacturing processes is considered to be substituted by the cycle of movement of WIP, whereby the appropriate quantity of WIP in respective processes can be computed. Production in respective processes is controlled such that the quantity of WIP is maintained, whereby the robustness of the overall manufacturing processes can be maintained.

Moreover, by means of high-speed simulation based on the CONSTIN technique, elaborate analysis becomes possible. Setting of an appropriate input rate and a product mix and examination of countermeasures against occurrence of mechanical failures which cannot be solved within the Period can be simulated with high accuracy.

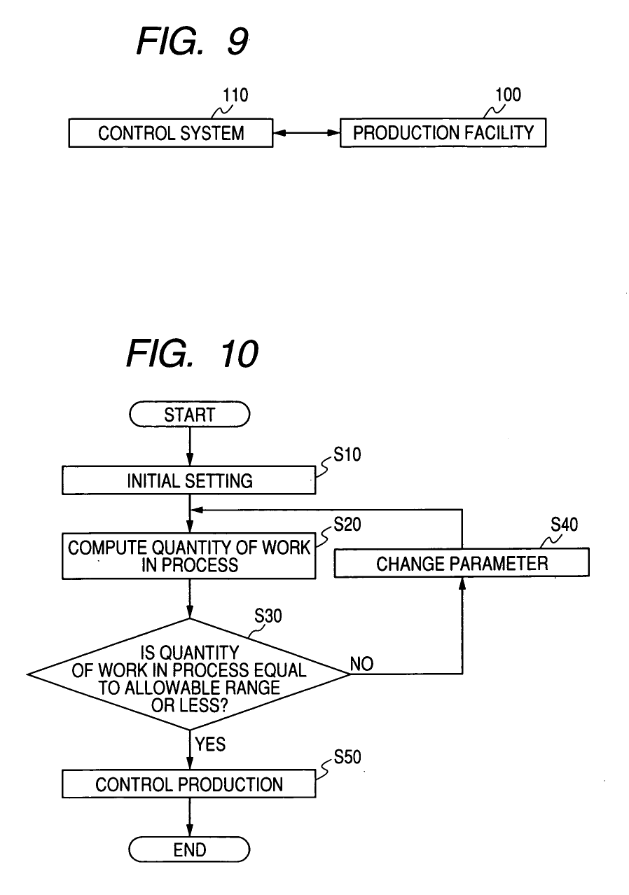

FIG. 9 shows the configuration of the production system for embodying the foregoing production method. In FIG. 9, reference numeral 100 designates a production facility installed along processes for manufacturing products. Reference numeral 110 designates a control system for controlling manufacturing processes of the production facility, and the control system has at least one computer. A control program of the present invention is stored in this control system 110. The essential requirement is to record the control program in a recording medium and install the program from the recording medium into the control system 110.

Details of processing to be executed by the control system 110 in accordance with the control program will now be described by reference to FIG. 10.

The control system 110 repeatedly performs processing procedures shown in FIG. 10 at a given cycle (processing defined by the function expressed in Mathematical Expression 6). The control system 110 initially sets various parameters showing production statuses of the manufacturing processes of the production facility; for example, the quantity of material input, thereby computing the quantity of WIP in respective processes within the manufacturing processes by virtue of the function expressed in Mathematical Expression 7 (from step S10 to S20). The initial setting values may be input beforehand by way of a keyboard or the like; or various parameters pertaining to production by means of the production facility may be measured and the result of measurement automatically input to the control system 110.

The control system 110 compares the result of computation of the quantity of WIP with a preset tolerance (step S30). When the result of computation of the quantity of WIP falls within the range of tolerance, the production facility 110 is controlled such that the quantity of WIP in actual manufacturing processes becomes equal to the set quantity of WIP (step S50).

In contrast, when the quantity of a shift in WIP does not fall within the range of tolerance, parameters to be used for computation are incremented (increased) or decremented (decreased) by only a predetermined value (step S40).

Specifically, when the quantity of WIP is smaller than the range of tolerance, the parameters are changed to increase the quantity of material input such that production of products is increased.

Manufacturing processes of the production facility 100 are controlled on the basis of the parameters (step S50). When the control system 110 performs processing pertaining to production control for each cycle (step 50), the quantity of products produced is increased, whilst the quantity of shift in WIP is decreased. As a result, when the quantity of WIP existing in the respective processes counted through use of measurement equipment (installedin the control system 110 shown in FIG. 1) which measures in real time the production status of a POP (Point of Production) system has become equal to the computation result of quantity of WIP set in step 20, production in the manufacturing processes of the production facility 100 is halted. In the next cycle, production control pertaining to step 50 is again performed, and production in the manufacturing processes of the production facility is resumed. By means of performing such a control operation, the control system 110 performs production such that the quantity of WIP is maintained constant at all times. Such a control operation is repeatedly performed at a given cycle. In the simulation for computing the quantity of WIP (the program for simulation performs the function of the simulator), the function of the time-interval-based simulator and that of the rule generator, both being described in the first embodiment, are imparted to the control system 110. It is better for the control system 110 to repeatedly compute the quantity of WIP in manufacturing processes through use of the production rule generated by the rule generator.

### DEFINITIONS AND MEANINGS OF TERMS

a. WIP

Materials or works in process which exist in production processes. This term does not include the inventory of finished products.

b. Quantity of Shift in WIP (quantity of shift)

Production proceeds as a result of the WIP “moving” through the processes. Therefore, the quantity of shift in WIP signifies the quantity of WIP to be processed through the processes in one cycle.

c. Workstation

Production machines (e.g., a stepper, a dry etching system, or the like)

d. Quantity of Products Input

The quantity of materials input into processes for producing products on the basis of a plan (based on demand forecasting). The input rate is the quantity of input per unit time. The plan is usually formulated so as to coincide with a demand rate (the quantity of demand per unit time).

e. Variations in Manufacturing Processes

Primarily variations in operation rate of machine responsible for failures and variations in manufacturing yield (the ratio of non-defective products in the quantity of all products) in the present patent application.

f. Movement Cycle

A cycle at which WIP moves

g. Robust

Often translated as “sturdiness” in Japanese. This signifies the ability to perform production as originally planned even when the above-described variations have arisen.

h. Trade-Off

A compromise arranged when a plurality of requirements are present.

i. Product Mix

A production proportion when a plurality of products are produced in one production process.

The above-described embodiments are illustrated for comprehension of the invention described in claims. Therefore, at the time of practice of the present invention, various modifications other than the foregoing embodiments are possible. The modifications fall within the technical scope of the present invention, so long as the modifications are based on the technical concept of the invention described in the claims.

### INDUSTRIAL APPLICABILITY

As has been described above, according to the present invention, an appropriate production rule (a part input rule or the like) can be automatically generated in connection with production processes which are objects of a production plan, a product mix, and the quantity of production, through use of a high-speed time-interval-based simulator. A high-quality production plan can be devised in connection with large-scale production processes of semiconductors or the like.

Further, according to the present invention, manufacturing processes are subjected to production control such that the quantity of WIP falls within the range of tolerance. Hence, useless WIP (a stock of parts) does not arise during the production processes. Moreover, the production efficiency is improved significantly.

1. A production plan devising system for formulating a production plan by means of simulating movement of a product in a factory by an event-based simulator through use of a production process model and a production rule, the production plan devising system comprising:
a time-interval-based simulator for computing the status of a production process at given time intervals; and
a rule generator for automatically deriving the production rule through use of the time-interval-based simulator.

2. The production plan devising system according to claim 1, wherein the production rule is formulated by means of a machine learning method based on a consecutive optimization technique using an artificial intelligence technique.

3. The production plan devising system according to claim 1, wherein the rule generator is constituted by a neural network.

4. A production plan devising method for formulating a production plan by means of simulating movement of a product in a factory by an event-based simulator through use of a production process model and a production rule, the production plan devising method employing a time-interval-based simulator for computing the status of a production process at given time intervals and a rule generator for automatically deriving the production rule through use of the time-interval-based simulator, the production plan devising method comprising:
a step for repeatedly devising a production plan over and over again by the time-interval-based simulator;
a step for applying mechanical learning based on a consecutive optimization technique to the rule generator;
a step for automatically formulating the production rule;
a step for using a generated production rule by the event-based simulator; and
a step for formulating a production rule.

5. A production plan devising program for formulating a production plan by means of simulating movement of a product in a factory by an event-based simulator through use of a production process model and a production rule, the production plan devising program comprising:
a time-interval-based simulator for computing the status of a production process at given time intervals; and
a rule generator for automatically deriving the production rule through use of the time-interval-based simulator,
wherein there are performed procedures by means of which the time-interval-based simulator repeatedly devises a production plan over and over again, thereby applying mechanical learning based on a consecutive optimization technique to the rule generator, so that the production rule is automatically formulated and the event-based simulator uses a generated production rule, thereby formulating a production rule.

6. A production system comprising:
a simulator for repeatedly computing the amount of WIP in manufacturing processes; and
a control system which determines a parameter to be used in computation of the simulator such that a computation result of the simulator becomes equal to an allowable range or less, and which controls the manufacturing processes on the basis of the parameter.

7. The production system according to claim 6, wherein the simulator comprises: a time-interval-based simulator for computing the status of a production process at given time intervals, and a rule generator for automatically deriving the production rule through use of the time-interval-based simulator, and the simulator repeatedly computes the quantity of WIP in manufacturing processes through use of a production rule generated by the generator.

8. The production system according to claim 6, wherein the control system has measurement equipment for measuring the amount of actual WIP in manufacturing processes; and, when the amount of actual WIP measured by the measurement equipment within a given cycle has become equal to a computation result of the simulator, the control system suspends production in manufacturing processes and resumes production in the next cycle.

9. The production system according to claim 8, wherein the given cycle can be variably set.

10. A production method comprising:
a step for repeatedly computing the amount of WIP in manufacturing processes by means of a simulator;
a step for determining a parameter to be used in computation of the simulator such that a computation result of the simulator becomes equal to an allowable range or less; and
a step for controlling the manufacturing processes by a control system on the basis of the parameter.

11. The production method according to claim 10, wherein the simulator comprises: a time-interval-based simulator for computing the status of a production process at given time intervals and a rule generator for automatically deriving the production rule through use of the time-interval-based simulator, and the simulator repeatedly computes the quantity of WIP in manufacturing processes through use of a production rule generated by the generator.

12. The production method according to claim 10, wherein the control system has measurement equipment for measuring the amount of actual WIP in manufacturing processes; and, when the amount of actual WIP measured by the measurement equipment within a given cycle has become equal to a computation result of the simulator, the control system suspends production in manufacturing processes and resumes production in the next cycle.

13. The production method according to claim 12, wherein the given cycle can be variably set.

14. A program to be performed by a production system, the program comprising:
a step for repeatedly computing the amount of WIP in manufacturing processes;
a step for determining a parameter to be used in computation of the simulator such that a computation result of the simulator becomes equal to an allowable range or less; and
a step for controlling the manufacturing processes on the basis of the parameter.

15. The program according to claim 14, wherein the production system comprises: a time-interval-based simulator for computing the status of a production process at given time intervals, and a rule generator for automatically deriving the production rule through use of the time-interval-based simulator, and the simulator performs processing pertaining to a step of repeatedly computing the quantity of WIP in manufacturing processes through use of a production rule generated by the generator.

16. The program according to claim 14, wherein the control system has measurement equipment for measuring the amount of actual WIP in manufacturing processes; and, when the amount of actual WIP measured by the measurement equipment within a given cycle has become equal to a computation result of the simulator, the control system suspends production in manufacturing processes and resumes production in the next cycle.

17. The production method according to claim 16, wherein the given cycle can be variably set.

18. A recording medium on which the program defined in claim 14 is recorded.
